(19) United States
(12) Patent Application Publication
(10) Pub. No.: US 2023/0289845 A1
(43) Pub. Date: Sep. 14, 2023

(54) ESTIMATION SYSTEM, ESTIMATION METHOD, AND PROGRAM RECORDING MEDIUM

(71) Applicant: NEC Corporation, Minato-ku, Tokyo (JP)

(72) Inventor: Naoki Yoshinaga, Tokyo (JP)

(73) Assignee: NEC Corporation, Minato-ku, Tokyo (JP)

(21) Appl. No.: 18/020,819

(22) PCT Filed: Sep. 28, 2020
(86) PCT No.: PCT/JP2020/036617

§ 371 Date: Feb. 10, 2023

(51) Int. Cl. G06Q 30/0207

(52) U.S. Cl. CPC G06Q 30/0224

(57) ABSTRACT

In order to accurately estimate the behavior suitable for transforming a customer into a good customer, an estimation system 100 is configured to comprise: an acquisition unit 101; an estimation unit 102; and an output unit 103. The acquisition unit 101 acquires purchase data including at least one among the purchase product, the total purchase amount, and the visit frequency of a target customer. The estimation unit 102 estimates a purchasing behavior for transforming the target customer into a good customer, on the basis of the purchase data acquired by the acquisition unit 101, by using an estimation model generated on the basis of the purchase data on a plurality of customers and the conditions of good customers. The output unit 103 outputs the purchasing behavior estimated by the estimation unit 102.

### TECHNICAL FIELD

The present invention relates to a technique for estimating an excellent customer, and particularly relates to a technique for estimating a behavior that transforms into an excellent customer.

### BACKGROUND ART

Sales support systems have been widely used for the purpose of improving efficiency of sales activities, improving business performance, and the like. For example, in the retail industry and the like, a technology of estimating an excellent customer such as a customer who is likely to purchase a product and a customer who purchases a large amount of product has been developed. As such a technology related to estimation of an excellent customer, for example, a technology such as PTL 1 is disclosed.

The advertisement apparatus of PTL 1 estimates a customer who is likely to purchase a product by using a model based on a behavior history of a customer who has purchased the product. The advertisement apparatus of PTL 1 increases an advertisement effect by targeting a customer who is likely to purchase a product as an advertisement distribution target.

### CITATION LIST

### Patent Literature

[PTL 1] JP 2015-230717 A

### SUMMARY OF INVENTION

### Technical Problem

In the technique of PTL 1, among customers whose behaviors are similar to that of a customer who has purchased a product, a customer who has not purchased a product is a candidate for advertisement distribution. However, in PTL 1, estimation is not performed in consideration of what state the customer is in.

In order to solve the above problems, an object of the present invention is to provide an estimation system and the like capable of accurately estimating a behavior for transforming a customer into an excellent customer.

### Solution to Problem

In order to solve the above problem, an estimation system of the present invention includes an acquisition unit, an estimation unit, and an output unit. The acquisition unit acquires purchase data including at least one of a purchase product, a total purchase amount, and a store visit frequency of a target customer. The estimation unit estimates a purchasing behavior for transforming the target customer into an excellent customer, based on the purchase data acquired by the acquisition unit, by using an estimation model generated based on purchase data of a plurality of customers and the conditions of excellent customers. The output unit outputs the purchasing behavior estimated by the estimation unit.

An estimation method of the present invention includes acquiring purchase data including at least one of a purchase product, a total purchase amount, and a store visit frequency of a target customer. The estimation method of the present invention includes estimating a purchasing behavior for transforming the target customer into an excellent customer based on the acquired purchase data using an estimation model generated based on purchase data of a plurality of customers and a condition of the excellent customer. The estimation method of the present invention including outputting the purchasing behavior estimated by the estimation unit.

The program recording medium of the present invention records an estimation program. The estimation program causes a computer to execute acquiring purchase data including at least one of a purchase product, a total purchase amount, and a store visit frequency of a target customer. The estimation program causes a computer to execute estimating a purchasing behavior for transforming the target customer into an excellent customer based on the acquired purchase data by using an estimation model generated based on the purchase data of a plurality of customers and a condition of the excellent customer. The estimation program causes a computer to execute outputting a purchasing behavior to be estimated.

### Advantageous Effects of Invention

According to the present invention, it is possible to accurately estimate a behavior for transforming a customer into an excellent customer.

### BRIEF DESCRIPTION OF DRAWINGS

FIG. 1 is a diagram illustrating an outline of a configuration of a first example embodiment of the present invention.

FIG. 2 is a diagram schematically illustrating an example of an operation of generating an estimation model according to the first example embodiment of the present invention.

FIG. 3 is a diagram schematically illustrating an example of an operation of generating an estimation model according to the first example embodiment of the present invention.

FIG. 4 is a diagram illustrating an operation flow of an estimation system according to the first example embodiment of the present invention.

FIG. 5 is a diagram illustrating an example of purchase data according to the first example embodiment of the present invention.

FIG. 6 is a diagram illustrating an example of data extracted from purchase data according to the first example embodiment of the present invention.

FIG. 7 is a diagram illustrating an operation flow of the estimation system according to the first example embodiment of the present invention.

FIG. 8 is a diagram illustrating an example of purchase data according to the first example embodiment of the present invention.

FIG. 9 is a diagram illustrating an example of a display screen of an estimation result according to the first example embodiment of the present invention.

FIG. 10 is a diagram illustrating an example of a display screen of an estimation result according to the first example embodiment of the present invention.

FIG. 11 is a diagram illustrating an example of a display screen of an estimation result according to the first example embodiment of the present invention.

FIG. 12 is a diagram illustrating an outline of a configuration of a second example embodiment of the present invention.

FIG. 13 is a diagram illustrating an operation flow of an estimation system according to the second example embodiment of the present invention.

FIG. 14 is a diagram illustrating an example of history data of actions according to the second example embodiment of the present invention.

FIG. 15 is a diagram illustrating an operation flow of an estimation system according to the second example embodiment of the present invention.

FIG. 16 is a diagram illustrating an example of a display screen of an estimation result according to the second example embodiment of the present invention.

FIG. 17 is a diagram illustrating an outline of a configuration of a third example embodiment of the present invention.

FIG. 18 is a diagram illustrating an operation flow of an estimation system according to the third example embodiment of the present invention.

FIG. 19 is a diagram illustrating an example of another configuration of the present invention.

### EXAMPLE EMBODIMENT

### First Example Embodiment

A first example embodiment of the present invention will be described in detail with reference to the drawings. The drawing is a diagram illustrating an outline of a configuration of an estimation system of the present example embodiment. The estimation system 10 of the present example embodiment includes an acquisition unit 11, a storage unit 12, a data generation unit 13, a generation unit 14, an estimation unit 15, and an output unit 16.

The acquisition unit 11, the storage unit 12, the data generation unit 13, the generation unit 14, the estimation unit 15, and the output unit 16 of the estimation system 10 may be provided in the same server, or may be provided in different servers in a distributed manner and connected via a network.

The estimation system 10 of the present example embodiment is a system that estimates a purchasing behavior of a customer who is likely to be an excellent customer. That is, the estimation system 10 of the present example embodiment is a system that estimates a purchasing behavior for transforming a target customer into an excellent customer. The excellent customer refers to, for example, a customer whose total purchase amount of products in a predetermined period is equal to or more than a standard, a customer who periodically purchases a specific product, or the like. The excellent customer may be based on another index such as a store visit frequency, the number of purchases, the rank of the membership system, or the number of points of the point system. The purchasing behavior includes not only a behavior of purchasing a product in practice but also a behavior related to purchase such as holding a product in a store, viewing a product shelf, visiting a store, or viewing a page of a product on a website. Hereinafter, a behavior related to purchase is also referred to as purchase related behavior.

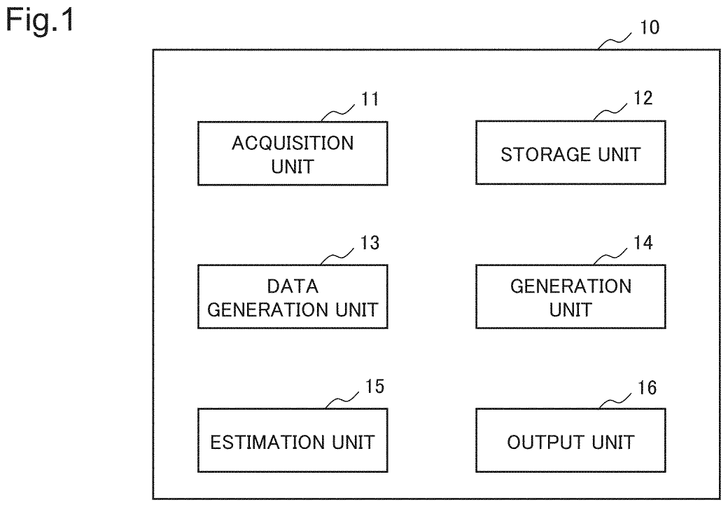

A configuration of the estimation system 10 will be described with reference to FIG. 1.

The acquisition unit 11 acquires data of a customer's purchasing behavior (hereinafter, it is also referred to as purchase data). Acquisition unit 11 acquires, for example, purchase data of a customer from a point of sale (POS) system of a retail store. Acquisition unit 11 may acquire the purchase data of the customer from a system other than a POS system such as a credit card management system or a point card management system used by the customer at the time of product purchase.

The customer purchase data refers to data related to purchase of a product by a customer. The purchase data of the customer includes, for example, one or a plurality of items of data such as a purchase date and time of a product, a product name of the purchased product, the number of purchases, a total purchase quantity, a purchase amount, or a total purchase amount.

The purchase data may include one or more items of the name of a store that has purchased the product, a given service, a given point, and a discount amount. The purchase data may include data regarding behavior related to purchase by the customer, such as a store visit frequency, the number of stop-off places in the store, and the number of stop-off places in the store. For example, when the store is constructed on the web, the data (that is, the purchase related behavior) related to the behavior related to the purchase of the customer may include, for example, clicking or tapping of each information of the website, presence or absence of browsing or logging-in of the member site, presence or absence of logging-in to the application, a browsing history of the product page, and the like. Among the behavior data regarding the purchase of the customer, data regarding behavior that is not directly related to the purchase of the product, such as clicking of each piece of information on the website, is also referred to as purchase related data.

The storage unit 12 stores the purchase data of the customer. The storage unit 12 stores data extracted from the purchase data and data generated based on the purchase data.

The data generation unit 13 extracts the purchasing behavior from the customer's purchase data. The data generation unit 13 also generates customer's state data from customer's purchase data. The state data refers to data indicating the state of the customer extracted from the purchase data of the customer. The state of the customer refers to the state of the customer when viewed from the side of selling the product. The state of the customer refers to, for example, a change in behavior of the customer such as a change in the total purchase amount of the product or a change in the total purchase quantity. The data of the state of the customer is used, for example, when determining an excellent customer for the retail store. The data indicating the state of the customer refers to, for example, data of one or more items of the total purchase amount in one store visit, the total purchase quantity in one store visit, the total purchase amount per unit period, the total purchase quantity in one store visit, the purchase frequency, the store visit frequency, and the number of acquired points. The data indicating the state of the customer may be the rank of the customer in a customer ranking system. The customer ranking system refers to a system in which customers are divided into a plurality of ranks based on customers' purchase results, and preferential services and the like are provided according to the ranks.

The generation unit 14 uses the purchase data of the customer or the state data extracted from the purchase data as input data, and generates an estimation model that outputs a purchasing behavior performed by a customer who changes into an excellent customer as an estimation result. The generation unit 14 generates an estimation model by machine learning in which the state data extracted from a customer's purchasing behavior or purchase data is used as input data and data indicating whether the customer is an excellent customer is used as a label for teacher data.

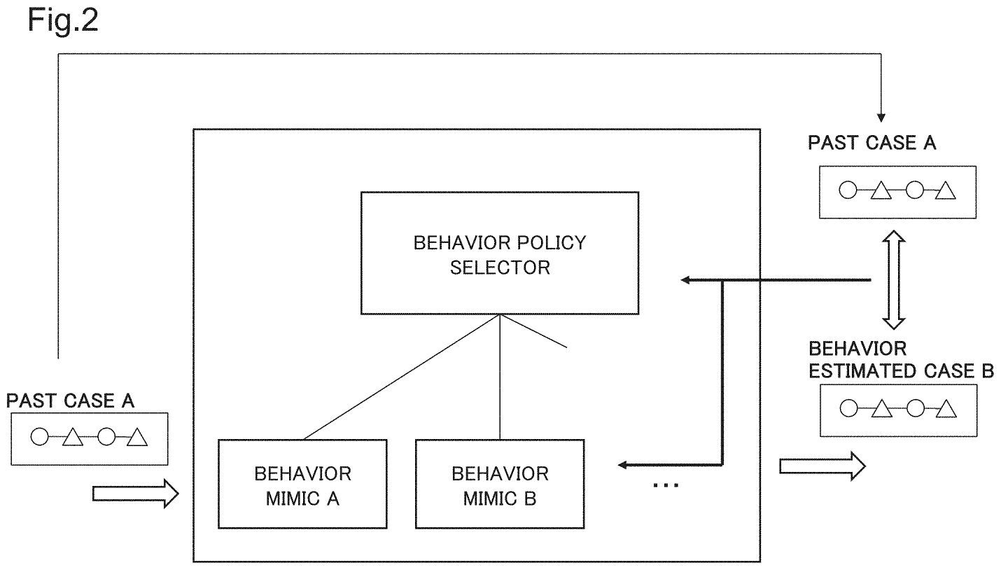

The generation unit 14 generates an estimation model using, for example, a Skill Acquisition Learning (SAiL) method. FIG. 2 is a diagram schematically illustrating an operation of generating an estimation model in the SAiL method.

In the SAiL method, the generation unit 14 uses a past case as an input and estimates a behavior to be performed next. In FIG. 2, with the purchase data of the customer as an input, the generation unit 14 estimates the next behavior performed by the excellent customer in a behavior mimic (behavior mimics A, B, . . . ). For example, when a past case A is input, the behavior mimic outputs an estimated case B of behavior. An arrow below the past case A on the left side indicates an input of the past case A to the generation unit 14. An arrow below the estimated case B of behavior indicates an output from the generation unit 14 of the estimated case B of behavior. The circles in the past case A and the estimated case B of behavior indicate the behavior of the customer. The triangle marks of the past case A and the estimated case B of behavior indicate the state of the customer after the behavior. The arrows between the past cases A indicate the same case. That is, in the past case A and the estimated case B in FIG. 2, it is indicated that the state of the customer has shifted to the state of the triangle mark by the customer taking the behavior of the circle mark (o).

When the next behavior is estimated, the generation unit 14 compares the input with the estimation result in the behavior policy selector, and selects the optimal behavior mimic based on the estimation accuracy. An arrow between the past case A and the behavior estimated case B in FIG. 2 indicates a comparison between the past case A as an input and the behavior estimated case B as an estimation result. The arrows pointing to the behavior policy selector and the behavior mimic on the left side of the comparison arrow indicate that the comparison result is input to the behavior policy selector and the behavior mimic.

The generation unit 14 generates an estimation model by simultaneously training the behavior policy selector and the behavior mimic based on the comparison result between the input and the estimation result.

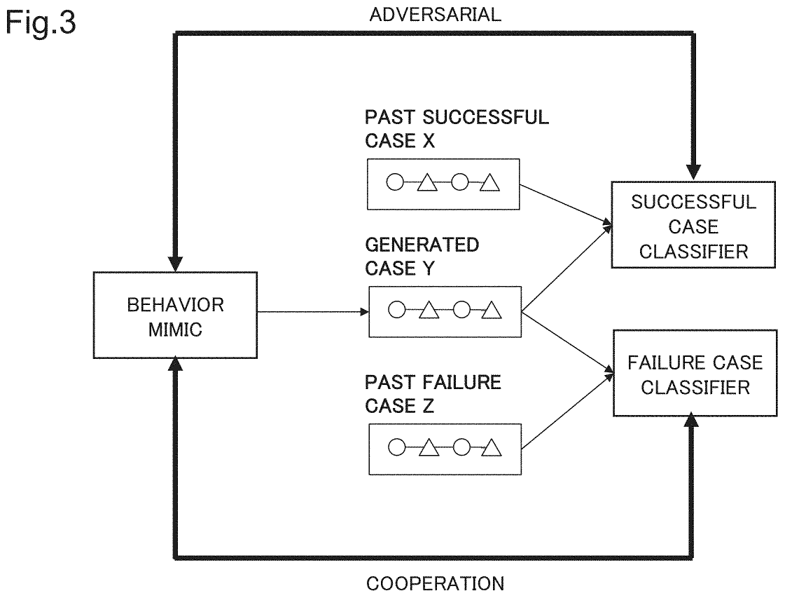

FIG. 3 is a diagram schematically illustrating an operation of optimizing the behavior mimic. The generation unit 14 generates a behavior mimic by an ACIL (Adversarial Cooperative Imitation Learning) method. The generation unit 14 compares a case generated by the behavior mimic with a past successful case in a successful case classifier that is a part of the behavior policy selector. The generation unit 14 compares a case generated by the behavior mimic with a past failure case in a failure case classifier which is a part of the behavior policy selector. The past successful case X in FIG. 3 is input data used as a positive example. The past failure case Z is input data used as a negative example. The generated case Y is data generated by the behavior mimic based on the input data. The circles in each case indicate the behavior of the customer similarly to the description in FIG. 2. The triangle marks in each case indicate the state of the customer after the behavior, similarly to the description in FIG. 2.

The successful case classifier performs an operation of distinguishing (or classifying) past successful cases and cases generated by the behavior mimic. Therefore, the behavior mimic and the successful case classifier advance training (selection of the optimal behavior mimic) while being adversarial with the behavior mimic that tries to approach the past successful case and the successful case classifier that tries to be distinguished. Adversarial refers to processing in which training is performed so that a difference between a successful case that is input data and a generated case that is an estimation result is reduced by further considering a small difference between the successful case classifier and the successful case classifier while the behavior mimic tries to generate a case that has a small difference from the successful case.

On the other hand, the failure case classifier performs an operation of distinguishing (or classifying) a past successful case and a failure case. Therefore, the behavior mimic and the failure case classifier advance training in cooperation with the behavior mimic that tries to keep away from the past failure cases and the successful case classifier that tries to be distinguished from the past failure cases. The cooperation refers to processing in which the behavior mimic tries to generate a case having a large difference from the failure case while the failure case classifier tries to select a case having a larger difference, so that the training is advanced such that the difference between the failure case as the input data and the generated case as the estimation result increases. As described above, by performing machine learning using both adversarial and cooperative, it is possible to obtain an estimation model capable of performing estimation with high accuracy without causing fatal failure.

Details of the ACIL and SAiL methods are described in Lu Wand et al., “Adversarial Cooperative Imitation Learning for Dynamic Treatment Regimes”, Proceedings of The Web Conference 2020 (WWW '20), [searched Sep. 3, 2020] Internet <URL: https://d1.acm.org/doi/10.1145/3366423.3380248>.

In the above description, the generation unit 14 performs machine learning using teacher data with a label indicating whether a customer is an excellent customer. However, the generation unit 14 may perform machine learning using a label set based on a predetermined key performance indicator (KPI). The label using the predetermined KPI includes at least one of a label set by a numerical value indicating a state of the customer such as a total purchase amount, a store visit frequency, the number of acquired points, or a rank of the customer. Note that the predetermined KPI is not limited to the above example as long as it is information regarding the purchasing behavior. The generation unit 14 performs machine learning using the training data of the positive example and the negative example to generate the estimation model, but the generation unit 14 may perform machine learning using only the training data of the positive example to generate the estimation model.

The estimation unit 15 estimates the purchasing behavior of transforming the customer into an excellent customer using the estimation model generated by generation unit 14. The estimation unit 15 uses the estimation model as the purchase data input of the customer to be estimated, and estimates the purchasing behavior of transforming an estimation target customer into an excellent customer as the estimation result. The estimation target customer is also referred to as a target customer.

The output unit 16 outputs the estimation result of the estimation unit 15. The output unit 16 may be a display control unit that controls the estimation result to be displayed on the display device.

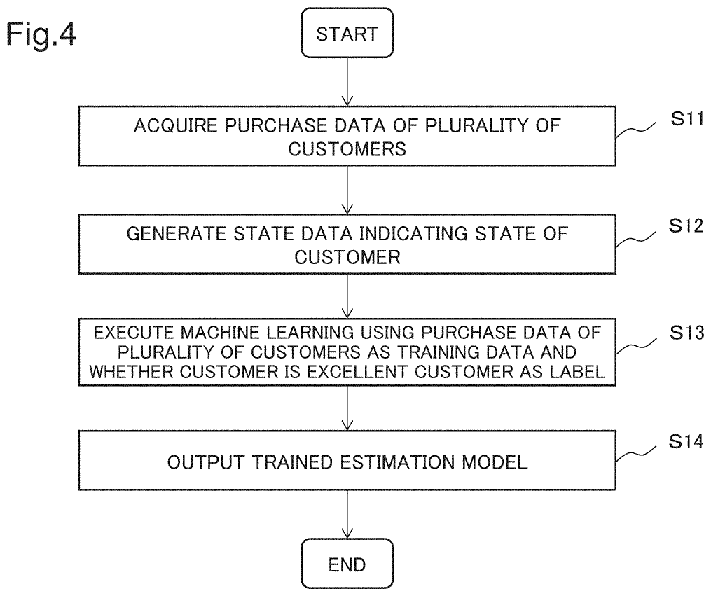

An operation of the estimation system 10 of the present example embodiment will be described. First, generation of an estimation model by machine learning will be described. FIG. 4 is a diagram illustrating a flow of an operation of generating an estimation model.

In FIG. 4, the acquisition unit 11 acquires past purchase data for a plurality of customers (step S11).

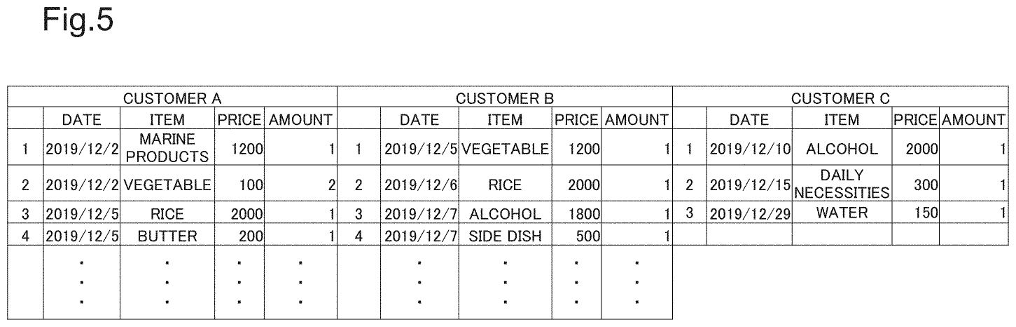

FIG. 5 is a diagram illustrating an example of purchase data of a customer. The purchase data of FIG. 5 includes data including the date of purchase of the product, the item of the purchased product, the price of the purchased product per product, and the number of products purchased for each product for the customer A, the customer B, and the customer C. In the example of FIG. 5, the date does not include time, but may include time. When acquiring the purchase data, the acquisition unit 11 stores the acquired purchase data in the storage unit 12.

When the purchase data is stored, the data generation unit 13 reads the purchase data from the storage unit 12 and extracts the purchasing behavior from the customer's purchase data. The data generation unit 13 generates state data indicating the state of the customer from the purchase data of the customer (step S12).

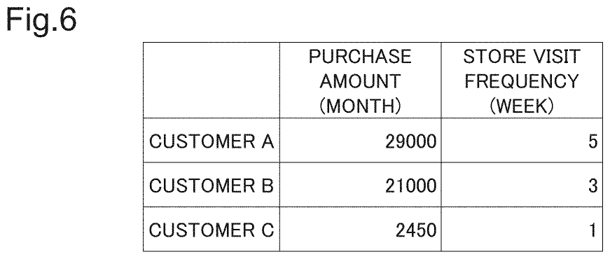

FIG. 6 is a diagram illustrating an example of state data of a customer. The state data of FIG. 6 includes a purchase amount per month for each customer and information on the store visit frequency. In the example of FIG. 6, the store visit frequency is indicated as the number of store visits per week. When the state data is generated, the data generation unit 13 stores the generated state data in the storage unit 12.

When the state data is stored, the generation unit 14 executes machine learning in which the purchase data of the customer is used as input data in machine learning, and data indicating whether the customer is an excellent customer is used as a label in teacher data (step S13).

In the examples of FIGS. 5 and 6, the generation unit 14 executes machine learning using a label with a purchased product purchased by a customer in the purchase data as input data and a total purchase amount in the state data as a criterion for an excellent customer. For example, the generation unit 14 executes machine learning by the SAiL method in which a case where the total purchase amount is equal to or more than 20,000 yen is a positive example and a case where the total purchase amount is less than 20,000 yen is a negative example, and generates an estimation model that predicts a purchasing behavior that transforms the customer into an excellent customer. After generating the estimation model, the generation unit 14 outputs the data of the trained estimation model to the estimation unit 15 (step S14).

When receiving the data of the estimation model, the estimation unit 15 stores the data of the estimation model inside, and uses the estimation model when estimating the purchasing behavior of the customer for becoming an excellent customer.

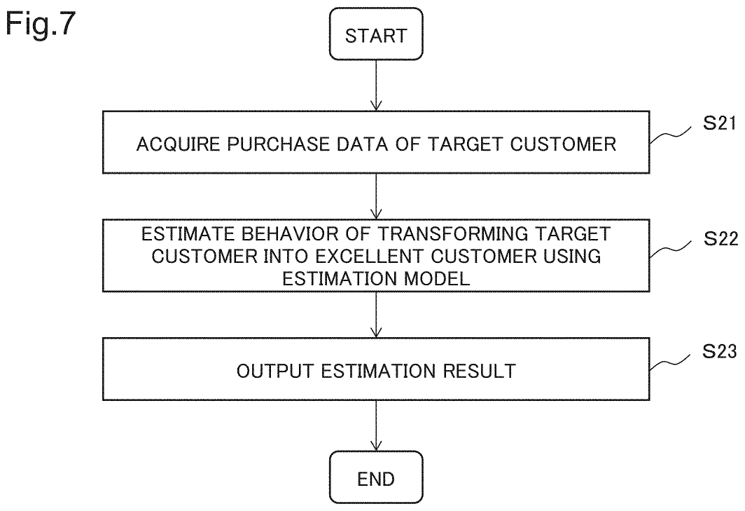

Next, an operation of estimating a purchasing behavior of a customer having a high probability of becoming an excellent customer using an estimation model will be described. FIG. 7 is a diagram illustrating an operation flow when estimating a purchasing behavior of a customer having a high probability of becoming an excellent customer in the estimation system 10.

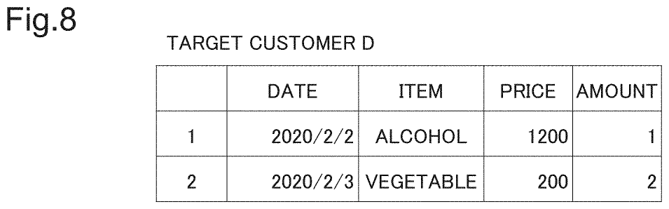

In FIG. 7, the acquisition unit 11 acquires the purchase data up to the estimation time point of time for the estimation target customer (step S21). FIG. 8 is a diagram illustrating an example of purchase data of a target customer. In FIG. 8, the target customer D is configured by data including the date of purchase of the product, the item of the purchased product, the price of one purchased product, and the number of purchased products for each product.

When acquiring the purchase data, the acquisition unit 11 stores the acquired data in the storage unit 12. The acquisition unit 11 may acquire the purchasing behavior of the target customer extracted in advance.

The data generation unit 13 reads the purchase data from the storage unit 12 and extracts the purchasing behavior of the customer from the purchase data. When extracting the purchasing behavior of the customer, the data generation unit 13 sends the extracted purchase data to the estimation unit 15.

When receiving the data of the purchasing behavior, the estimation unit 15 estimates the purchasing behavior of transforming the customer into an excellent customer using the estimation model generated by the generation unit 14 (step S22). For example, the estimation unit 15 uses the purchasing behavior up to the estimation time point of the customer as input data, and estimates the purchasing behavior with a high probability that the customer will be an excellent customer using the estimation model. When estimating the purchasing behavior with a high probability that the customer will be an excellent customer, the estimation unit 15 sends the estimation result to the output unit 16.

When receiving the estimation result, the output unit 16 outputs the estimation result. The output unit 16 displays the estimation result on the display device, for example. The output unit 16 outputs the estimation result of the purchasing behavior for the estimation target customer to be an excellent customer (step S23). The output unit 16 may output the estimation result to the terminal device of the user or another information processing device connected via a network.

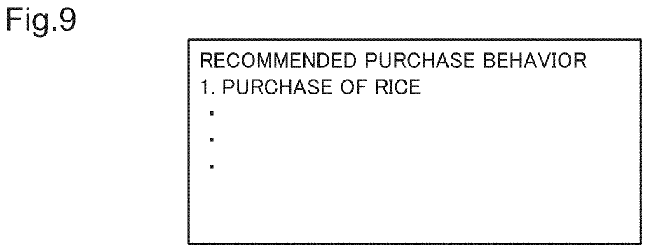

FIG. 9 is a diagram illustrating an example of a display screen of an estimation result. In the example of FIG. 9, the purchasing behavior with a high probability that a target customer becomes an excellent customer is shown as the purchasing behavior recommended. The output unit 16 displays the purchasing behavior as the recommended purchasing behavior in descending order of the probability that a target customer becomes an excellent customer. The example of the display screen in FIG. 9 indicates that “purchasing rice” is the purchasing behavior with the highest probability that the target customer will be an excellent customer. The user of the estimation system 10 can increase the possibility that the target customer becomes an excellent customer by referring to the display result illustrated in FIG. 9 and executing a measure for causing the target customer to purchase rice.

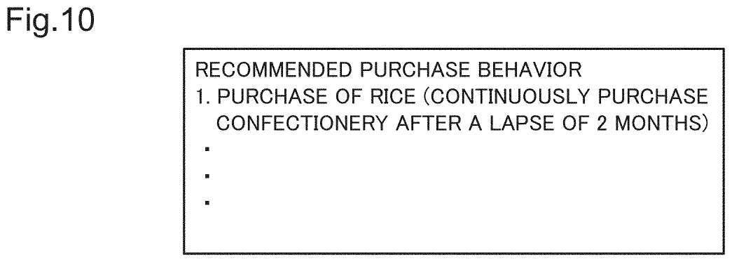

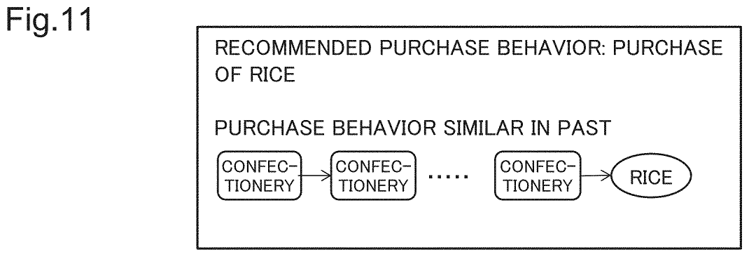

FIG. 10 illustrates an example in which the reason why the purchasing behavior is recommended is displayed on the display screen of the estimation result similar to that in FIG. 9. The example of FIG. 10 indicates that there is a high possibility that a person who continuously purchases confectionery and purchases rice after a lapse of 2 months will become an excellent customer. The example of FIG. 11 illustrates an example of another display form of the estimation result similar to that of FIG. 10. In the example of FIG. 11, the behavior of rice is presented as the recommended purchasing behavior. In FIG. 11, it is visualized that the possibility of becoming an excellent customer is increased by purchasing rice after continuously purchasing confectionery as the purchasing behavior. The user of the estimation system 10 can increase the possibility that the target customer will be an excellent customer by recommending rice at a stage where the target customer has already continued confectionery and recommending the confectionery to the target customer before the stage.

The estimation system 10 of the present example embodiment estimates a purchasing behavior for making a target customer an excellent customer by using an estimation model generated by using purchase data including a purchasing behavior. When the estimation is performed using the estimation model, the purchase data of the target customer to be estimated is used as an input, whereby the purchasing behavior that increases the possibility that the target customer becomes an excellent customer can be estimated based on the current state of the target customer. The estimation system 10 of the present example embodiment can perform estimation with higher accuracy for each target customer by estimating a purchasing behavior that increases the possibility of becoming an excellent customer based on the state of the target customer. Therefore, the user of the estimation system 10 can increase the possibility that the customer will be an excellent customer by referring to the estimation result of the purchasing behavior that increases the possibility that the target customer will be an excellent customer and executing a measure to cause the target customer to perform the estimated purchasing behavior.

### Second Example Embodiment

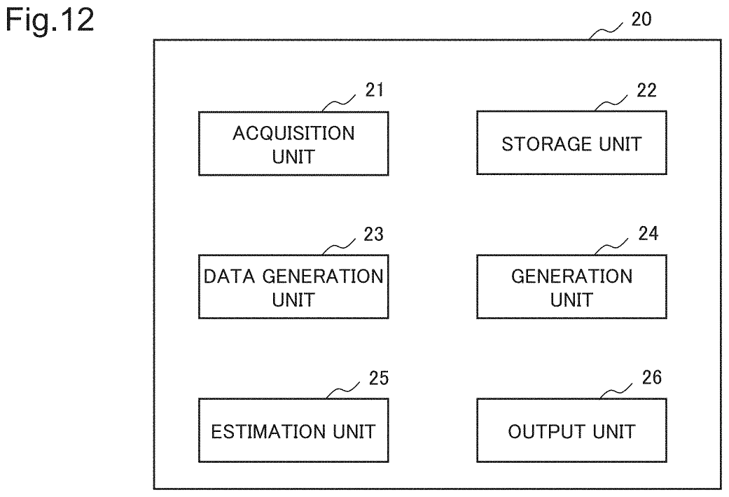

A second example embodiment of the present invention will be described in detail with reference to the drawings. FIG. 12 is a diagram illustrating an outline of a configuration of an estimation system 20 of the present example embodiment. The estimation system 20 of the present example embodiment includes an acquisition unit 21, a storage unit 22, a data generation unit 23, a generation unit 24, an estimation unit 25, and an output unit 26.

The acquisition unit 21, the storage unit 22, the data generation unit 23, the generation unit 24, the estimation unit 25, and the output unit 26 of the estimation system 20 may be provided in the same server, or may be provided in different servers in a distributed manner and connected via a network.

The estimation system 10 according to the first example embodiment estimates the purchasing behavior of the target customer himself/herself with a high probability that the target customer will be an excellent customer. For such a configuration, the estimation system 20 of the present example embodiment estimates an action to be performed on the target customer in order to increase the possibility that the target customer becomes an excellent customer.

The acquisition unit 21 acquires the purchase data of the customer and the history data of the action performed on the customer. The action performed on the customer refers to, for example, a behavior performed on the customer to urge the customer to purchase the product. The action to be performed on the customer refers to, for example, one or more items of phone invitation, mail transmission, display of product information on a web page, display of product information on an application of a smartphone, delivery of a discount coupon, delivery of benefit information, granting of a point, provision of a sample, notification of holding of an event, and implementation of a seminar. The action is not limited to the above as long as the action can promote the purchasing behavior of the customer.

The acquisition unit 21 may acquire, in addition to the history data of the action performed on the customer, response data of the customer to the action performed on the customer. The customer response data is, for example, data indicating a record of whether the customer has accessed a website described in an e-mail when the e-mail is transmitted to the customer. The customer response data may be, for example, data indicating a record of whether the customer has opened an application or accessed the notification when the notification is made via the application installed in the terminal device of the customer.

The storage unit 22 stores purchase data of the customer and history data of actions performed on the customer. In a case where response data of the customer to an action performed on the customer is acquired, the storage unit 22 stores the response data of the customer.

Similarly to the data generation unit 13 of the first example embodiment, the data generation unit 23 extracts the purchasing behavior from the customer purchase data. The data generation unit 23 generates state data from the purchase data of the customer. The acquisition unit 21 may acquire the purchasing behavior extracted in advance.

The generation unit 24 generates an estimation model that uses the purchasing behavior of the target customer and the action performed on the target customer as input data, and outputs the action performed on the customer to make the target customer an excellent customer. The generation unit 24 generates the estimation model by machine learning using teacher data in which the purchasing behavior of the customer and the action performed on the target customer are input data of machine learning and data indicating whether the customer is an excellent customer is a label. Similarly to the first example embodiment, the generation unit 24 generates an estimation model using, for example, the SAiL method. Similarly to the generation unit 14 of the first example embodiment, the generation unit 24 may perform machine learning using a label set based on a predetermined KPI to generate an estimation model. Similarly to the generation unit 14 of the first example embodiment, the generation unit 24 may perform machine learning using only training data of a normal example to generate an estimation model.

The estimation unit 25 estimates an action to be performed on a customer in order to make the customer an excellent customer by using the estimation model generated by the generation unit 24. The estimation unit 25 performs estimation using the estimation model with the purchasing behavior of the estimation target customer and the action for the customer up to the estimation time point as inputs, and outputs an action to be performed for the customer in order to make the estimation target customer an excellent customer as an estimation result. The generation unit 24 may regenerate the estimation model by retraining using an action actually performed on the customer based on the estimation result of the estimation unit 25 and a result of whether the customer has become an excellent customer. By performing retraining, the accuracy of estimation by the estimation model can be improved.

The output unit 26 outputs the estimation result of the estimation unit 25. The output unit 26 may be a display control unit that controls the estimation result to be displayed on the display device.

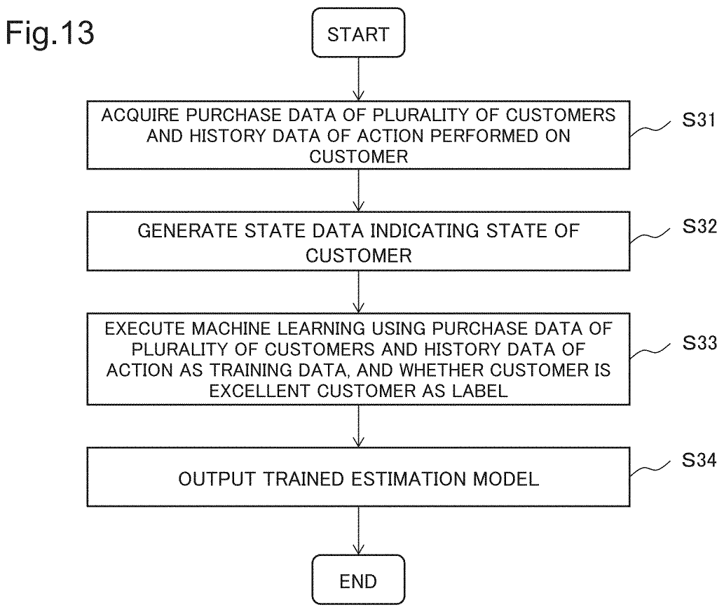

An operation of the estimation system 20 of the present example embodiment will be described. First, an operation at the time of generating an estimation model for estimating an action to be performed to make the target customer an excellent customer in the estimation system 20 will be described. FIG. 13 is a diagram illustrating an operation flow when an estimation model for estimating an action for making a target customer an excellent customer is generated.

In FIG. 13, the acquisition unit 21 acquires past purchase data for a plurality of customers and history data of actions performed on the customers (step S31).

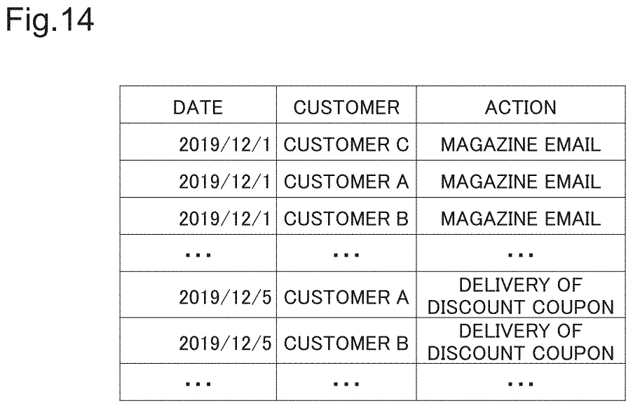

FIG. 14 is a diagram illustrating an example of history data of an action performed on a customer. The history data of the action performed on the customer in FIG. 14 includes information on the date when the action was performed on the customer, the customer who performed the action, and the type of the action performed on the customer. The acquisition unit 21 acquires data as illustrated in FIG. 5 as the purchase data similarly to the first example embodiment. When acquiring the purchase data and the data of the action performed on the customer, the acquisition unit 21 stores the acquired data in the storage unit 22.

The data generation unit 23 reads the purchase data from the storage unit 22, and generates the purchasing behavior and state data of the customer from the purchase data as in the first example embodiment (step S32). When the purchasing behavior and the state data are generated, the data generation unit 23 stores the purchasing behavior and the state data in the storage unit 22.

When the purchasing behavior and the state data are saved, the generation unit 24 executes the machine learning using teacher data in which the purchasing behavior of the target customer and the action performed on the target customer are used as input data of the machine learning and data indicating whether the customer is an excellent customer is used as a label (step S33). The generation unit 24 generates an estimation model that estimates an action to be performed on a customer in order to make the customer an excellent customer by machine learning using the SAiL method. After generating the estimation model, the generation unit 24 outputs the data of the trained estimation model to the estimation unit 25 (step S34).

When receiving the data of the estimation model, the estimation unit 25 stores the data of the estimation model therein, and uses the estimation model in estimating an action for a customer to make the customer an excellent customer.

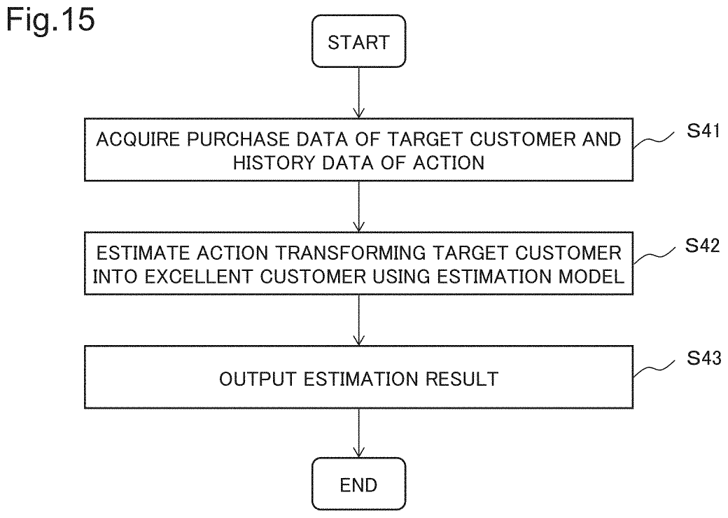

Next, an operation of estimating an action for a customer to make the customer an excellent customer will be described using the estimation model. FIG. 15 is a diagram illustrating a flow of an operation in which the estimation system 20 estimates an action for a customer to make the customer an excellent customer using an estimation model.

In FIG. 15, the acquisition unit 21 acquires the action performed on the customer up to the estimation time point and the purchase data of the estimation target customer (step S41). When acquiring the action and the purchase data performed on the customer, the acquisition unit 21 stores the acquired data in the storage unit 22.

The data generation unit 23 reads the purchase data from the storage unit 22 and extracts the purchasing behavior of the target customer from the purchase data. After extracting the purchasing behavior of the target customer, the data generation unit 23 sends the purchasing behavior of the target customer to the estimation unit 25.

When receiving the purchase data of the target customer, the estimation unit 25 uses the purchasing behavior of the customer and the action for the customer up to the estimation time point as input data, and estimates the action for the target customer for making the target customer an excellent customer using the estimation model (step S42). When estimating the purchasing behavior for making the target customer an excellent customer, the estimation unit 25 transmits the estimation result to the output unit 26.

When receiving the estimation result, the output unit 26 outputs an estimation result of an action for the customer to make the target customer an excellent customer (step S43). The output unit 26 displays the estimation result on the display device, for example. The output unit 26 may output the estimation result to the terminal device of the user or another information processing device connected via a network.

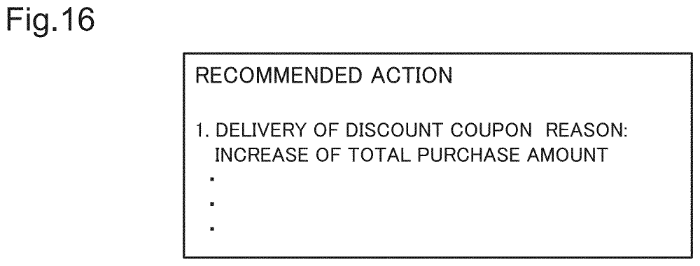

FIG. 16 is a diagram illustrating an example of a display screen of an estimation result. In FIG. 16, an action for a target customer to make the customer an excellent customer is displayed as a recommended action. In FIG. 16, the actions for making the target customer an excellent customer are illustrated in descending order of the possibility that the target customer will be an excellent customer. In the example of FIG. 16, the action of delivering a discount coupon to a customer is illustrated as an action with the highest probability to be an excellent customer. In the example of FIG. 16, the reason is illustrated that the total purchase amount increases due to the delivery of the discount coupon.

The estimation system 20 of the present example embodiment estimates an action for a customer to make the target customer an excellent customer by using an estimation model generated by using purchase data of the customer and a history of actions performed on the customer. When the estimation is performed using the estimation model, the action for making the target customer an excellent customer can be estimated based on the current state of the target customer by performing estimation using the purchase data of the target customer to be estimated as an input. In the estimation system 20 of the present example embodiment, it is possible to perform estimation with higher accuracy for each target customer by estimating an action for the customer to be an excellent customer based on the purchase data of the target customer and the history of the actions.

### Third Example Embodiment

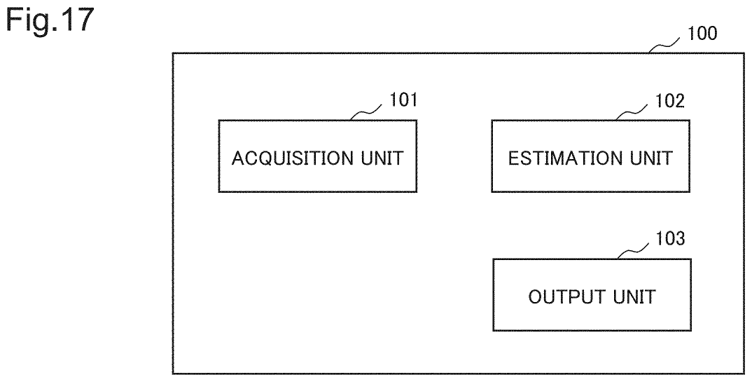

An operation of the estimation system of the present invention will be described. FIG. 17 is a diagram illustrating a configuration of an estimation system of the present example embodiment. An estimation system 100 of the present example embodiment includes an acquisition unit 101, an estimation unit 102, and an output unit 103. The acquisition unit 101 acquires purchase data including at least one of the purchase product, the total purchase amount, and the store visit frequency of a target customer. The estimation unit 102 estimates a purchasing behavior for transforming the target customer into an excellent customer, based on the purchase data acquired by the acquisition unit 101, by using an estimation model generated based on the purchase data of a plurality of customers and the conditions of excellent customers. The output unit 103 outputs the purchasing behavior estimated by the estimation unit 102.

Here, the acquisition unit 11 of the first example embodiment and the acquisition unit 21 of the second example embodiment are examples of the acquisition unit 101. The acquisition unit 101 is an aspect of an acquisition means. The estimation unit 15 of the first example embodiment and the estimation unit 25 of the second example embodiment are examples of the estimation unit 102. The estimation unit 102 is an aspect of an acquisition means. The output unit 16 of the first example embodiment and the output unit 26 of the second example embodiment are examples of the output unit 103. The output unit 103 is an aspect of an output means.

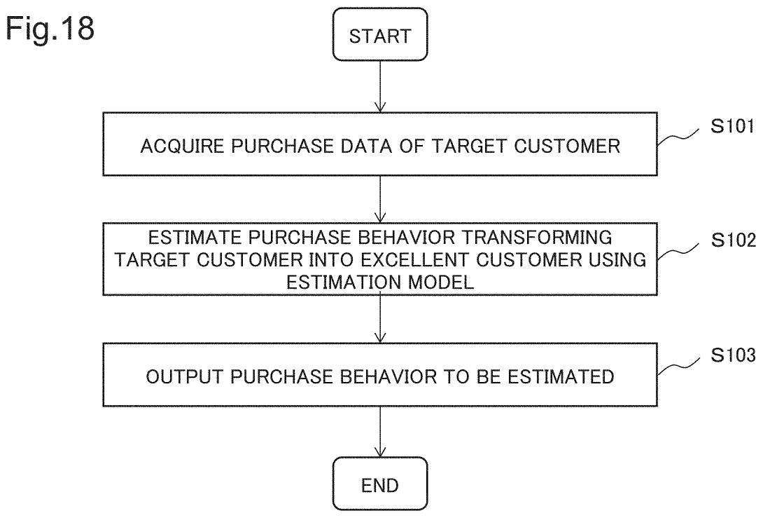

An operation of the estimation system 100 of the present example embodiment will be described. FIG. 18 is a diagram illustrating an operation flow of the estimation system 100.

The acquisition unit 101 acquires the purchase data including at least one of the purchase product, the total purchase amount, and the store visit frequency of the target customer (step S101). When the purchase data is acquired, the estimation unit 102 estimates the purchasing behavior for transforming the target customer into an excellent customer based on the purchase data acquired by the acquisition unit 101 using the estimation model generated based on the purchase data of the plurality of customers and the condition of the excellent customer (step S102). When the purchasing behavior for transforming the target customer into an excellent customer is estimated, the output unit 103 outputs the purchasing behavior estimated by the estimation unit 102 (step S103).

The estimation system 100 of the present example embodiment can improve the accuracy of the estimation of the purchasing behavior for making the target customer an excellent customer by estimating the purchasing behavior for making the target customer an excellent customer based on the current state of the target customer.

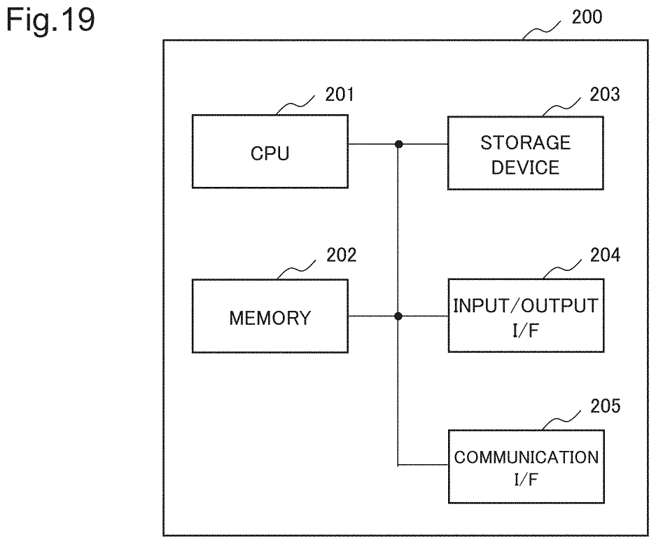

Each processing in the estimation system of the first to third example embodiments can be performed by executing a computer program on a computer. FIG. 19 illustrates an example of a configuration of a computer 200 that executes a computer program for performing each processing in the estimation system according to the first to third example embodiments. The computer 200 includes a central processing unit (CPU) 201, a memory 202, a storage device 203, an input/output interface (I/F) 204, and a communication I/F 205.

The CPU 201 reads and executes the computer program for performing each processing from the storage device 203. The CPU 201 may be configured by a combination of a CPU and a graphics processing unit (GPU). The memory 202 includes a dynamic random access memory (DRAM) or the like, and temporarily stores a computer program executed by the CPU 201 and data being processed. The storage device 203 stores a computer program executed by the CPU 201. The storage device 203 includes, for example, a non-volatile semiconductor storage device. As the storage device 203, another storage device such as a hard disk drive may be used. The input/output I/F 204 is an interface that receives an input from an operator and outputs display data and the like. The communication I/F 205 is an interface that transmits and receives data to and from each device constituting the estimation system, a terminal of a user, and the like.

The computer program used for executing each processing can be stored in a recording medium and distributed. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as a recording medium.

Some or all of the above example embodiments may be described as the following Supplementary Notes, but are not limited to the following.

### [Supplementary Note 1]

An estimation system including:
an acquisition means configured to acquire purchase data including at least one of a purchase product, a total purchase amount, and a store visit frequency of a target customer;
an estimation means configured to estimate a purchasing behavior for transforming the target customer into an excellent customer based on the purchase data acquired by the acquisition means by using an estimation model generated based on purchase data of a plurality of customers and a condition of the excellent customer; and
an output means configured to output the purchasing behavior estimated by the estimation means.

### [Supplementary Note 2]

The estimation system according to Supplementary Note 1, in which
the output means further outputs data contributing to the estimation among the purchase data acquired by the acquisition means.

### Supplementary Note 3

The estimation system according to Supplementary Note 1 or 2, in which
the acquisition means acquires an action performed in a past to transform a purchasing behavior of the target customer,
the estimation means estimates an action for transforming the target customer into an excellent customer based on an action acquired by the acquisition means using the estimation model generated further based on an action performed in a past to transform a purchasing behavior of each of the plurality of customers, and
the output means outputs the action estimated by the estimation means.

### [Supplementary Note 4]

The estimation system according to any one of Supplementary Notes 1 to 3, in which
the purchase data includes at least one of an unpurchased product picked up by the target customer, position information in a store, and an access history to a website or an application of the store.

### [Supplementary Note 5]

The estimation system according to any one of Supplementary Notes 1 to 4, in which
the purchasing behavior to be output by the output means is at least one of increasing a number of store visits, increasing a purchase amount, and purchasing a specific product.

### [Supplementary Note 6]

The estimation system according to Supplementary Note 3, in which
the action output by the output means is at least one of delivering of a discount coupon, delivering of discount information of a product, delivering of benefit information, providing of a sample, and notification of holding of an event.

### [Supplementary Note 7]

The estimation system according to any one of Supplementary Notes 1 to 6, further including:
a generation means configured to generate the estimation model by machine learning using a label indicating the excellent customer, with purchase data of the plurality of customers as input data.

### [Supplementary Note 8]

The estimation system according to Supplementary Note 7, in which
the generation means generates the estimation model by further using input data using a negative example which does not satisfy a criterion indicating the excellent customer.

### [Supplementary Note 9]

The estimation system according to Supplementary Note 7 or 8, in which
a label indicating the excellent customer is set based on a predetermined key performance indicator (KPI).

### [Supplementary Note 10]

An estimation method including:
acquiring purchase data including at least one of a purchase product, a total purchase amount, and a store visit frequency of a target customer;
estimating a purchasing behavior for transforming the target customer into an excellent customer based on the acquired purchase data using an estimation model generated based on purchase data of a plurality of customers and a condition of the excellent customer; and
outputting the purchasing behavior to be estimated.

### [Supplementary Note 11]

The estimation method according to Supplementary Note 10, further including: further outputting data contributing to the estimation among acquired purchase data.

### [Supplementary Note 12]

The estimation method according to Supplementary Note 10 or 11, further including:
acquiring an action performed in a past to transform a purchasing behavior of the target customer;
estimating an action for transforming the target customer into an excellent customer based on an acquired action using the estimation model generated further based on an action performed in a past to transform a purchasing behavior of each of the plurality of customers; and
outputting the action to be estimated.

### [Supplementary Note 13]

The estimation method according to any one of Supplementary Notes 10 to 12, in which the purchase data includes at least one of an unpurchased product picked up by the target customer, position information in a store, and an access history to a website or an application of the store.

### [Supplementary Note 14]

The estimation method according to any one of Supplementary Notes 10 to 13, in which the purchasing behavior to be output includes at least one of increasing a number of store visits, increasing a purchase amount, and purchasing a specific product.

### [Supplementary Note 15]

The estimation method according to Supplementary Note 12, in which
the action to be output is at least one of delivering of a discount coupon, delivering of discount information of a product, delivering of benefit information, providing of a sample, and notification of holding of an event.

### [Supplementary Note 16]

The estimation method according to any one of Supplementary Notes 10 to 15, further including: generating the estimation model by machine learning using a label indicating the excellent customer, with purchase data of the plurality of customers as an input.

### [Supplementary Note 17]

The estimation method according to Supplementary Note 16, further including: generating the estimation model by further using input data using a negative example which does not satisfy a criterion indicating the excellent customer.

### [Supplementary Note 18]

The estimation method according to Supplementary Note 16 or 17, in which a label indicating the excellent customer is set based on a predetermined key performance indicator (KPI).

### [Supplementary Note 19]

A program recording medium recording an estimation program for causing a computer to execute:
acquiring purchase data including at least one of a purchase product, a total purchase amount, and a store visit frequency of a target customer;
estimating a purchasing behavior for transforming the target customer into an excellent customer based on the acquired purchase data by using an estimation model generated based on the purchase data of a plurality of customers and a condition of the excellent customer; and
outputting the purchasing behavior to be estimated.

### [Supplementary Note 20]

The program recording medium recording the estimation program according to Supplementary Note 19, causing a computer to execute:
further outputting data contributing to the estimation among purchase data to be acquired.

### [Supplementary Note 21]

The program recording medium recording the estimation program according to Supplementary Note 19 or 20, causing a computer to execute:
acquiring an action performed in a past to transform a purchasing behavior of the target customer;
estimating an action for transforming the target customer into an excellent customer based on an acquired action using the estimation model generated further based on an action performed in a past to transform a purchasing behavior of each of the plurality of customers; and
outputting the action to be estimated.

### [Supplementary Note 22]

The program recording medium according to any one of Supplementary Notes 19 to 21, in which the purchase data includes at least one of an unpurchased product picked up by the target customer, position information in a store, and an access history to a website or an application of the store.

### [Supplementary Note 23]

The program recording medium according to any one of Supplementary Notes 19 to 22, in which a purchasing behavior to be output is any one of increasing a number of store visits, increasing a purchase amount, and purchasing a specific product.

### [Supplementary Note 24]

The program recording medium according to Supplementary Note 21, in which an action to be output is at least one of delivering of a discount coupon, delivering of discount information of a product, delivering of benefit information, providing of a sample, and notification of holding of an event.

### [Supplementary Note 25]

The program recording medium recording the estimation program according to any one of Supplementary Notes 19 to 24, causing a computer to execute:
generating the estimation model by machine learning using a label indicating the excellent customer, with purchase data of the plurality of customers as an input.

### [Supplementary Note 26]

The program recording medium recording the estimation program according to Supplementary Note 25, causing a computer to execute:
generating the estimation model by further using input data using a negative example which does not satisfy a criterion indicating the excellent customer.

### [Supplementary Note 27]

The program recording medium according to Supplementary Note 25 or 26, in which a label indicating the excellent customer is set based on a predetermined key performance indicator (KPI).

The present invention has been described above using the above-described example embodiments as schematic examples. However, the present invention is not limited to the above-described example embodiments. That is, the present invention can apply various aspects that can be understood by those of ordinary skill in the art without departing from the spirit and scope of the present invention.

### REFERENCE SIGNS LIST

10 estimation system
11 acquisition unit
12 storage unit
13 data generation unit
14 generation unit
15 estimation unit
16 output unit
20 estimation system
21 acquisition unit
22 storage unit
23 data generation unit
24 generation unit
25 estimation unit
26 output unit
100 estimation system
101 acquisition unit
102 estimation unit
103 output unit
200 computer
201 CPU
202 memory
203 storage device
204 input/output I/F
205 communication I/F

What is claimed is:

1. An estimation system comprising:
at least one memory storing instructions; and
at least one processor configured to access the at least one memory and execute the instructions to:
acquire purchase data including at least one of a purchase product, a total purchase amount, and a store visit frequency of a target customer;
estimate a purchasing behavior for transforming the target customer into an excellent customer based on the acquired purchase data by using an estimation model generated based on purchase data of a plurality of customers and a condition of the excellent customer; and
output the estimated purchasing behavior.

2. The estimation system according to claim 1, wherein
the at least one processor is further configured to execute the instructions to:
output data contributing to the estimation among the acquired purchase data.

3. The estimation system according to claim 1, wherein
the at least one processor is further configured to execute the instructions to:
acquire an action performed in a past to transform a purchasing behavior of the target customer;
estimate an action for transforming the target customer into an excellent customer based on an action acquired by using the estimation model generated further based on an action performed in a past to transform a purchasing behavior of each of the plurality of customers; and
output the estimated action.

4. The estimation system according to claim 1, wherein
the purchase data includes at least one of an unpurchased product picked up by the target customer, position information in a store, and an access history to a website or an application of the store.

5. The estimation system according to claim 1, wherein
the output purchasing behavior is at least one of increasing a number of store visits, increasing a purchase amount, and purchasing a specific product.

6. The estimation system according to claim 3, wherein
the output action is at least one of delivering of a discount coupon, delivering of discount information of a product, delivering of benefit information, providing of a sample, and notification of holding of an event.

7. The estimation system according to claim 1, wherein
the at least one processor is further configured to execute the instructions to:
generate the estimation model by machine learning using a label indicating the excellent customer, with purchase data of the plurality of customers as input data.

8. The estimation system according to claim 7, wherein
generate the estimation model by further using input data using a negative example which does not satisfy a criterion indicating the excellent customer.

9. The estimation system according to claim 7, wherein
a label indicating the excellent customer is set based on a predetermined key performance indicator (KPI).

10. An estimation method comprising:
acquiring purchase data including at least one of a purchase product, a total purchase amount, and a store visit frequency of a target customer;
estimating a purchasing behavior for transforming the target customer into an excellent customer based on the acquired purchase data using an estimation model generated based on purchase data of a plurality of customers and a condition of the excellent customer; and
outputting the purchasing behavior to be estimated.

11. The estimation method according to claim 10, further comprising: further outputting data contributing to the estimation among acquired purchase data.

12. The estimation method according to claim 10, further comprising:
acquiring an action performed in a past to transform a purchasing behavior of the target customer;
estimating an action for transforming the target customer into an excellent customer based on an acquired action using the estimation model generated further based on an action performed in a past to transform a purchasing behavior of each of the plurality of customers; and
outputting the action to be estimated.

13. The estimation method according to claim 10, wherein the purchase data includes at least one of an unpurchased product picked up by the target customer, position information in a store, and an access history to a website or an application of the store.

14. The estimation method according to claim 10, wherein the purchasing behavior to be output includes at least one of increasing a number of store visits, increasing a purchase amount, and purchasing a specific product.

15. The estimation method according to claim 12, wherein
the action to be output is at least one of delivering of a discount coupon, delivering of discount information of a product, delivering of benefit information, providing of a sample, and notification of holding of an event.

16. The estimation method according to claim 10, further comprising: generating the estimation model by machine learning using a label indicating the excellent customer, with purchase data of the plurality of customers as an input.

17. The estimation method according to claim 16, further comprising: generating the estimation model by further using input data using a negative example which does not satisfy a criterion indicating the excellent customer.

18. The estimation method according to claim 16, wherein a label indicating the excellent customer is set based on a predetermined key performance indicator (KPI).

19. A non-transitory program recording medium recording an estimation program for causing a computer to execute:
acquiring purchase data including at least one of a purchase product, a total purchase amount, and a store visit frequency of a target customer;
estimating a purchasing behavior for transforming the target customer into an excellent customer based on the acquired purchase data by using an estimation model generated based on the purchase data of a plurality of customers and a condition of the excellent customer; and
outputting the purchasing behavior to be estimated.

20-27. (canceled)
